(19) United States
(12) Patent Application Publication
(10) Pub. No.: US 2012/0134438 A1
(43) Pub. Date: May 31, 2012

(54) METHOD AND APPARATUS FOR DETECTING RECEIVED SIGNAL IN WIRELESS COMMUNICATION SYSTEM

(75) Inventors: Hwa-Sun YOU, Suwon-si (KR); Hyo-Yol Park, Seoul (KR)

(73) Assignee: Samsung Electronics Co. Ltd., Suwon-si (KR)

(21) Appl. No.: 13/303,877

(22) Filed: Nov. 23, 2011

(30) Foreign Application Priority Data
Nov. 25, 2010 (KR) 10-2010-0118086

(51) Int. Cl. H04L 27/06; H04L 27/00; H04L 27/18; H04L 27/22

(52) U.S. Cl. 375/279; 375/341; 375/329; 375/259

(57) ABSTRACT

A method for detecting a received signal by a Base Station (BS) in a communication system is provided. The method includes receiving a BandWidth Request (BW REQ) indicator, determining first interference signal streams representing BW REQ messages, determining whether the first interference signal streams include at least one second interference signal stream which is in a null state, determining a first Maximum Likelihood (ML) metric, determining a second ML metric for each of a case where a value of bits constituting each of third interference signal streams except for the at least one second interference signal stream among the first interference signal streams is 1, and calculating a minimum error distance of the BW REQ messages received from Mobile Stations (MSs) based on the first ML metrics and the second ML metrics.

### PRIORITY

This application claims the benefit under 35 U.S.C. §119(a) of a Korean patent application filed in the Korean Intellectual Property Office on Nov. 25, 2010 and assigned Serial No. 10-2010-0118086, the entire disclosure of which is hereby incorporated by reference.

### BACKGROUND OF THE INVENTION

1. Field of the Invention

The present invention relates to a wireless communication system. More particularly, the present invention relates to a method and apparatus for detecting received signals in a wireless communication system.

2. Description of the Related Art

A cellular communication system supports simultaneous access by multiple Mobile Stations (MSs) in such a manner that a Base Station (BS) allocates resources, such as time, frequency, code and space, to multiple MSs. To reduce latency, which may occur in an UpLink (UL) resource request channel due to the simultaneous access by MSs, a random access channel is used, in which specific time and frequency resources are allocated.

In this random access channel, when multiple MSs attempt access simultaneously, contention may occur. In order to increase its reception performance, the BS communicates with MSs using multiple receive antennas. Therefore, since Multiple User-Multiple Input Multiple Output (MU-MIMO) channels are already formed between the BS and the MSs, the contention probability may be reduced by applying a space division function to the random access channel, thus making it possible to increase data throughput.

The random access channel does not have a feature of identifying spatial channels for individual MSs, causing the high probability of contention. Even though the ability to identify spatial channels is provided by applying a MIMO reception function to the random access channel, due to the random access channel's characteristics that it is not possible to determine in advance whether or not an MS has transmitted data, a MIMO receiver may not use the Maximum Likelihood (ML) detection technique, which is known to provide the optimal performance, causing an increase in probability of false alarm in terms of the detection performance.

Therefore, there is a need for a MIMO ML detection scheme in a random access channel, in which the random access channel's characteristics are taken into account.

### SUMMARY OF THE INVENTION

Aspects of the present invention are to address at least the above-mentioned problems and/or disadvantages and to provide at least the advantages described below. Accordingly, an aspect of the present invention is to provide a Multiple Input Multiple Output (MIMO) Maximum Likelihood (ML) detection method and apparatus in which the random access channel's characteristics are taken into account.

Another aspect of the present invention is to provide an ML detection method and apparatus, in which, upon receiving a BandWidth REQuest (BW REQ) indicator over a random access channel, a Base Station (BS) detects an ML for a BW REQ message using a probability of failure to receive the BW REQ message among the BW REQ messages corresponding to the BW REQ indicator.

In accordance with an aspect of the present invention, a method for detecting a received signal by a BS in a communication system is provided. The method includes receiving a BW REQ indicator from each of Mobile Stations (MSs) over a random access channel, determining first interference signal streams representing BW REQ messages, the number of which corresponds to the number of the received BW REQ indicators, determining whether the first interference signal streams include at least one second interference signal stream which is in a null state, if there is no second interference signal stream, determining a first ML metric for each of a case where a value of bits constituting each of the first interference signal streams is 1 and a case where the bit value is 0, if the at least one second interference signal stream is in a null state, determining a second ML metric for each of a case where a value of bits constituting each of third interference signal streams except for the at least one second interference signal stream among the first interference signal streams is 1, and a case where the bit value is 0, and calculating a minimum error distance of the BW REQ messages received from the MSs based on the first ML metrics and the second ML metrics.

In accordance with another aspect of the present invention, an apparatus for detecting a received signal in a communication system is provided. The apparatus includes a receiver for receiving a BW REQ indicator from each of MSs over a random access channel, and a detector for determining first interference signal streams representing BW REQ messages, the number of which corresponds to the number of the received BW REQ indicators, for determining whether the first interference signal streams include at least one second interference signal stream which is in a null state, if there is no second interference signal stream, for determining a first ML metric for each of a case where a value of bits constituting each of the first interference signal streams is 1 and a case where the bit value is 0, if the at least one second interference signal stream is in a null state, for determining in advance a second ML metric for each of a case where a value of bits constituting each of third interference signal streams except for the at least one second interference signal stream among the first interference signal streams is 1, and a case where the bit value is 0, and for calculating a minimum error distance of the BW REQ messages received from the MSs based on the first ML metrics and the second ML metrics.

In accordance with further another aspect of the present invention, a method for transmitting a signal in a communication system is provided. The method includes sending both a BW REQ indicator and a BW REQ message to a BS if resources susceptible to latency should be requested, and receiving from the BS a notification indicating allocation of requested resources that are allocated according to information included in the BW REQ message.

In accordance with yet another aspect of the present invention, an apparatus for transmitting a signal in a communication system is provided. The apparatus includes a transmitter for sending both a BW REQ indicator and a BW REQ message to a BS if resources susceptible to latency should be requested, and a receiver for receiving from the BS a notification indicating allocation of requested resources that are allocated according to information included in the BW REQ message.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates a resource structure of a general (BW REQ) channel;

FIG. 2 illustrates a process of requesting allocation of UpLink (UL) resources using only a BW REQ indicator;

FIG. 3 illustrates a process of requesting allocation of UL resources by sending both a BW REQ indicator and a BW REQ message according to an exemplary embodiment of the present invention;

FIG. 4 illustrates a structure of a Base Station (BS) according to an exemplary embodiment of the present invention;

FIG. 5 illustrates a structure of a Maximum Likelihood (ML) detector according to an exemplary embodiment of the present invention; and

FIG. 6 illustrates an operation of an ML detector according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

A description will now be made of a Multiple Input Multiple Output (MIMO) Maximum Likelihood (ML) detection method and apparatus in which the random access channel's characteristics are taken into account in a wireless communication system. Although a BandWidth REQuest (BW REQ) channel in the Institute of Electrical and Electronics Engineers (IEEE) 802.16m system will be considered as an example of the random access channel, it will be understood by those of ordinary skill in the art that exemplary embodiments of the present invention are not necessarily applied only to the BW REQ channel. The BW REQ channel is a physical channel used by a Mobile Station (MS) to request UpLink (UL) resources.

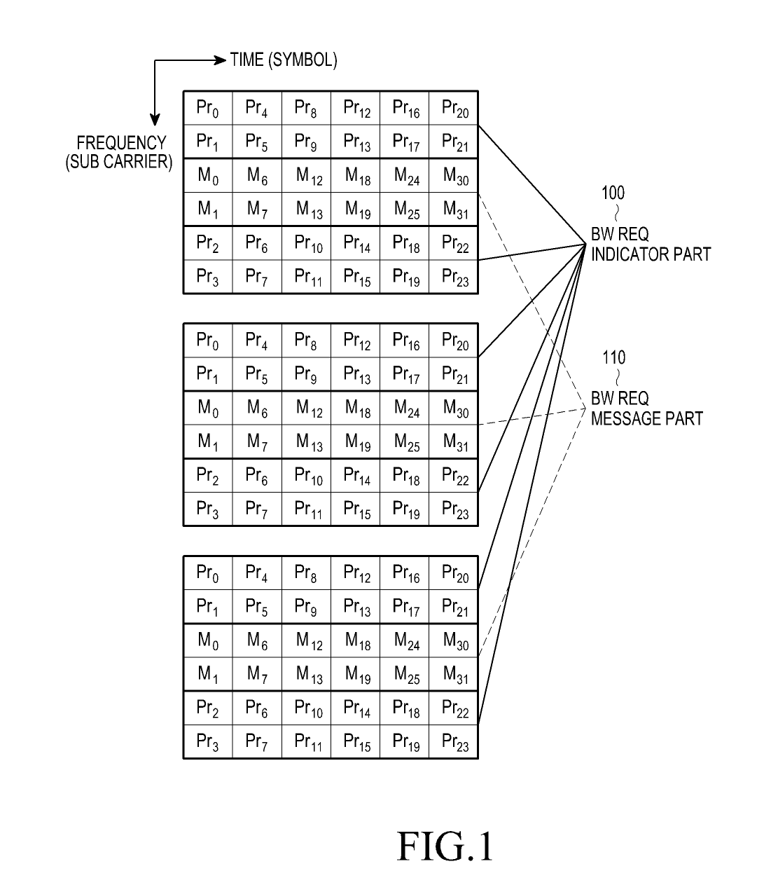

FIGS. 1 through 6, discussed below, and the various exemplary embodiments used to describe the principles of the present disclosure in this patent document are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the invention. Terms first, second, and the like are used to differentiate between objects having the same terminology and are in no way intended to represent a chronological order, unless where explicitly stated otherwise. A set is defined as a non-empty set including at least one element.

FIG. 1 illustrates a resource structure of a general BW REQ channel.

Referring to FIG. 1, one BW REQ channel includes three frequency-time resource tiles having the same size, making it possible to obtain the frequency diversity effect. All frequency-time resource tiles are divided into BW REQ indicator parts 100 for BW REQ indicators and BW REQ message parts 110 for BW REQ messages.

One BW REQ indicator may be repeatedly sent in the form of an orthogonal signal stream {Pr₀, Pr₁, Pr₂, . . . , Pr₂₃} with a length of 24, for each frequency-time resource tile. One BW REQ message is sent in the form of a Quadrature Phase Shift Keying (QPSK) modulation signal stream {M₀, M₁, M₂, . . . , M₃₅} having undergone channel coding in the center frequency range for each of the three frequency-time resource tiles.

When an MS desires to be allocated UL resources, the MS may send only a BW REQ indicator to a Base Station (BS) over the BW REQ channel, or may send both a BW REQ indicator and a BW REQ message. A difference between these two cases may cause changes in the UL resource request and allocation procedure.

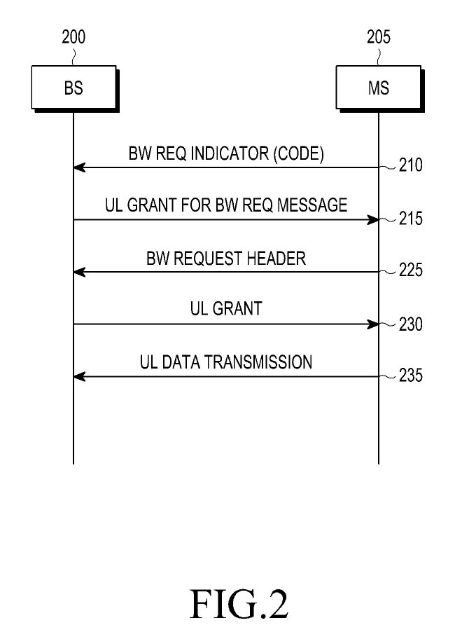

FIG. 2 illustrates a process of requesting allocation of UL resources using only a BW REQ indicator.

Referring to FIG. 2, upon receiving a BW REQ indicator from an MS 205 in step 210, a BS 200 recognizes occurrence of a BW REQ request. At this moment, the BS 200 has no detailed BW REQ information, such as to which MS and in which size it should allocate UL resources. Therefore, in step 215, the BS 200 allocates UL resources for a BW REQ message including detailed BW REQ information and sends a UL grant indicating the allocated UL resources to the MS 205.

Upon receiving the UL grant, the MS 205 generates a BW request header having a BW REQ message including its own identification information (for example, station ID, caller ID, and the like) and requested resource size information, and sends the BW request header to the BS 200 using the granted UL resources in step 225.

Upon receiving the BW request header, the BS 200 reflects in a scheduler the information acquired from the BW REQ message included in the BW request header, and sends the MS 205 a UL grant indicating that it grants the requested resources corresponding to the acquired information to the MS 205, in step 230. In step 235, the MS 205 transmits UL data to the BS 200 using the UL resources corresponding to the UL grant.

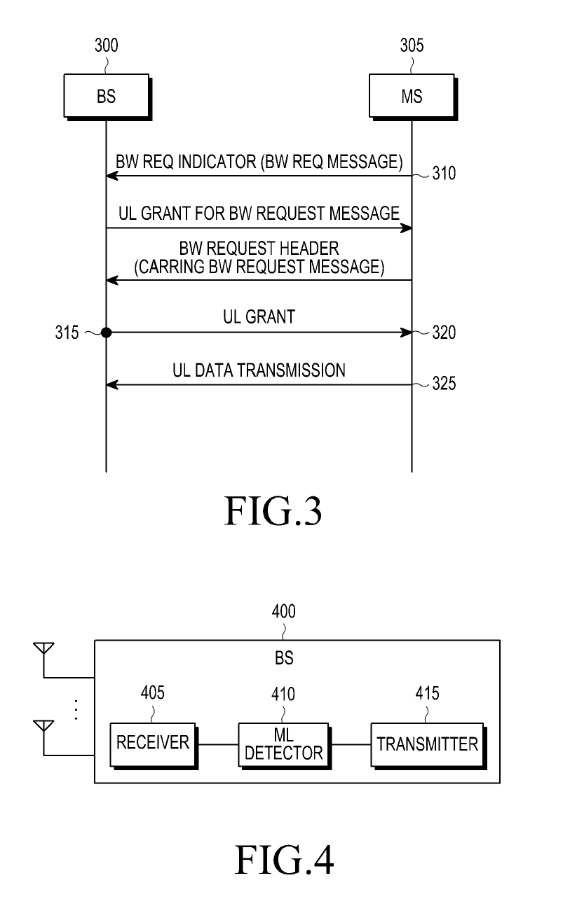

Since the UL resource request procedure of FIG. 2 needs at least five signaling exchanges between the MS and the BS, this procedure is required to be improved when the MS requests UL resources susceptible to latency, for real-time traffic and urgent transmission. Therefore, the signaling procedure may be simplified as shown in FIG. 3 by the MS's utilizing the resource region for the BW REQ message parts 110 in FIG. 1.

FIG. 3 illustrates a process of requesting allocation of UL resources by sending both a BW REQ indicator and a BW REQ message according to an exemplary embodiment of the present invention.

Referring to FIG. 3, an MS 305, which may urgently be allocated UL resources, sends both a BW request indicator and BW REQ message to a BS 300 in step 310. The BW REQ message includes the minimum detailed information related to the UL resource request, such as MS identification information (e.g., station ID, caller ID, and the like) and requested resource size information.

Upon receiving the BW REQ indicator and the BW REQ message, the BS 300 reflects in a scheduler the information acquired from the BW REQ message in step 315, omitting steps 215 and 225 in FIG. 2, and sends the MS 305 a UL grant indicating that it grants the requested resources corresponding to the acquired information to the MS 305, in step 320. In step 335, the MS 305 transmits UL data to the BS 300 using the UL resources corresponding to the UL grant.

As a result, as the MS 305 sends both the BW REQ indicator and the BW REQ message, the signaling procedure may be reduced to three steps compared with the signaling procedure in which the MS sends only the BW REQ indicator, contributing to a reduction in latency.

However, in response to the BW REQ message, unlike in response to the BW REQ indicator, the BS directly allocates the requested UL resources without additional verification. Therefore, when a reception error occurs, the BS may allocate UL resources to an MS requiring no UL resources, or may allocate UL resources unnecessarily large in size to an MS, causing degradation in the overall performance of the UL system.

In the case of, for example, a BW REQ channel of the IEEE 802.16m system, a BW REQ indicator includes a total of 24 orthogonal signal streams randomly selected by an MS. Therefore, if each of MSs differently selects orthogonal signal streams constituting its own BW REQ indicator, the BS may identify BW REQ indicators received from the MSs, even though the MSs send their BW REQ indicators over the same BW REQ channel.

On the other hand, since the BW REQ message is received in the form of a QPSK modulation signal stream, if multiple MSs send BW REQ messages simultaneously, they may interfere with each other, thereby deteriorating reception performance of the BS.

To address these problems, a method of limiting by the BS the number of MSs sending BW REQ messages over the same BW REQ channel may be considered. More specifically, the BS selects (or determines the number of) MSs that should be urgently allocated UL resources, such as MSs performing initial call setup or starting a specific service flow. Accordingly, the BS grants only the selected MSs to send both a BW REQ indicator and a BW REQ message, and sends the selected MSs a grant message for indicating the grant and for sending of BW REQ messages. In this case, an MS having failed to receive the grant message from the BS performs a UL resource request procedure in accordance with FIG. 2, since it may not send both a BW REQ indicator and a BW REQ message, for UL resource request.

However, even though the BS has received a BW REQ indicator from an MS to which it sent the grant message, the BS should additionally determine whether it has received the BW REQ message from the MS, or determine reliability of the reception, because it is not possible to guarantee that the BW REQ message has been received together.

Therefore, in the following proposed method and apparatus, the BS selects (or determines the number of) MSs that should be urgently allocated UL resources, and sends a grant message to the selected MSs to perform the simplified UL resource allocation procedure of FIG. 3 with the selected MSs. Thereafter, upon receiving BW REQ indicators from any MSs among the selected MS, the BS determines whether it has received BW REQ messages together from the MSs having sent the BW REQ indicators, or determines reliability of the reception.

An exemplary embodiment of the present invention provides a method of determining the reception of BW REQ messages using a MIMO ML detection scheme, in order to allow the BS to simultaneously receive one or more BW REQ messages over a BW REQ channel.

A MIMO ML detection scheme is defined as Equation (1) below:

$${\hat{s}}_{t} = min \{ {\sum }_{r} {( {y}_{r} - {\sum }_{t} {h}_{r , t} {s}_{t} )}^{2} \} \qquad ( 1 )$$

where r represents an indicator for a receive antenna, t represents an indicator (or an indicator of a BW REQ message) of a data stream transmitted from an MS, yᵣ represents data received from a receive antenna corresponding to an r^{th} indicator, sₜ represents a QPSK modulation signal of a BW REQ message, that an MS corresponding to a t^{th} indicator sends, and h_{r,t} represents a complex response of a wireless channel between receive antennas of an MS corresponding to a t^{th} indicator and a BS corresponding to an r^{th} indicator.

Equation (1) may be rewritten as Equation (2) below in an equivalent way using a vector-matrix:

ŝ=min{∥y−Hs∥²} (2)

where y represents a column vector having [y₁, y₂, . . . , y_{R}] as its elements, s represents a column vector having [s₁, s₂, . . . , s_{T}] as its elements, and H represents an R×T matrix having h_{r,t} in an r^{th} row and a t^{th} column as its elements. Herein, R≧T is assumed to guarantee the BS's ability to detect BW REQ messages, where R represents the number of receive antennas and T represents the number of data streams transmitted from an MS.

The MIMO ML detection scheme is implemented to find a combination of QPSK modulation signals, having the highest probability that an error distance with a QPSK modulation signal reconfigured for all possible combinations of modulation signals transmitted by all MSs, i.e., QPSK modulation signals representing BW REQ messages, is close to the minimum value. Therefore, the MIMO ML detection scheme is available only when the number of QPSK modulation signals transmitted by MSs is accurately known. Although the BS operates a receiver on the assumption that two data streams are transmitted, if only one data stream is actually transmitted, reception performance of ML detection for the received data stream is significantly reduced. To describe this problem by applying it to a case where the receiver receives a BW REQ message, it will be assumed that the receiver has detected two BW REQ indicators transmitted from an MS. In this case, the BS may not guarantee that two BW REQ messages have been received from the MS. Therefore, some MSs should send only a BW REQ indicator because they have not received a grant message from the BS as there is no need to simplify the BW REQ procedure as shown in FIG. 3, or because transmission power is insufficient due to the UL coverage issue. Accordingly, the BS may not accurately calculate the number of BW REQ messages sent from MSs, and may merely assume that the number of BW REQ messages is less than or equal to the number N_ind of BW REQ indicators detected by the BS. As a result, it is difficult for the BS to directly apply the MIMO ML detection scheme in detecting BW REQ messages.

In order to acquire even coding gain by means of a channel decoder based on the ML detection results, soft decision results should be extracted and input to the channel decoder, and the required soft decision is expressed in the form of a Log Likelihood Ratio (LLR) represented by Equation (3) below:

$$\begin{matrix}LLR ( {b}_{i} ) = log \frac{P ( {b}_{i} = 1 \vert y )}{P ( {b}_{i} = 0 \vert y )} \\ = log \{ \frac{{\sum }_{{s}^{1} ∈ {C}_{i}^{1}} P ( y \vert s = {s}^{1} ) P ( s = {s}^{1} )}{{\sum }_{{s}^{0} ∈ {C}_{i}^{0}} P ( y \vert s = {s}^{0} ) P ( s = {s}^{0} )} \}\end{matrix} \qquad ( 3 )$$

where bᵢ represents a bit included in a QPSK modulation signal stream, and since BW REQ messages the BS has received are QPSK modulation signals, each BW REQ message includes 2 bits (b₀,b₁). In addition, Cᵢ¹ represents a set of half QPSK modulation signal streams s¹ whose bᵢ value is ‘1’ (bᵢ₌₁) in the set of all possible s, and C₁⁰ represents a set of the remaining half QPSK modulation signal streams s⁰ whose bᵢ value is ‘0’ (bᵢ₌₀).

For example, when the BS receives 2 QPSK modulation signal streams, a total of 16 combinations of column vectors s=[s₀, s₁] are possible for the two QPSK modulation signal streams. Among them, sets cᵢ⁰ and cᵢ¹ of modulation signal streams for an i^{th} bit are both 8 in size. In this case, an LLR may be calculated using Equation (4) below:

$$LLR ( {b}_{i} ) = min ( \frac{{‖ y - {Hs}^{0} ‖}^{2}}{2 {σ}^{2}} {\vert}_{{s}^{0} ∈ {C}_{i}^{0}} ) - min ( \frac{{‖ y - {Hs}^{1} ‖}^{2}}{2 {σ}^{2}} {\vert}_{{s}^{1} ∈ {C}_{i}^{1}} ) \qquad ( 4 )$$

where σ represents a standard deviation of additive noise.

In other words, a received BW REQ message may be reconfigured by a product of each QPSK modulation signal stream set and the channel, and an LLR may be calculated based on a difference in the minimum error distance between the reconfigured BW REQ message and the actually received BW REQ message.

However, the BS may not determine the number of BW REQ messages sent from MSs. Therefore, in the following description, the ML detection scheme is implemented by defining as interference signal streams the QPSK modulation signal streams of BW REQ messages, the number of which corresponds to the number of BW REQ indicators the BS has received, and reception of which is uncertain, and by adding, to a candidate QPSK symbol set of the interference signal streams, the state in which the BW REQ message has not been received, i.e., the null state in which values of a real part and an imaginary part of the symbol are both set to ‘0’.

FIG. 4 illustrates a structure of a BS according to an exemplary embodiment of the present invention.

Referring to FIG. 4, a BS 400 includes a receiver 405, an ML detector 410, and a transmitter 415. The receiver 405 receives data streams from MSs along with or independently of, for example, BW REQ indicators and BW REQ messages, and delivers them to the ML detector 410. The ML detector 410 detects an ML metric based on the null state for the interference signal streams, the number of which corresponds to the number of the BW REQ indicators the receiver 405 has received. The transmitter 415 sends a grant message for sending of BW REQ messages to the MSs, which are known to the BS 400 in advance and should be urgently allocated UL resources.

Upon acquiring BW REQ indicators from the receiver 405, the ML detector 410 assumes that the BS 400 has received BW REQ messages, the number of which is less than or equal to the number of the BW REQ indicators. For example, if the receiver 405 has received two BW REQ indicators, the ML detector 410 assumes that the number of received BW REQ messages is less than or equal to the number, 2, of the BW REQ indicators. The ML detector 410 defines, as interference signal streams, the QPSK modulation signal streams of the two BW REQ messages the BS 400 can receive. When calculating an LLR for a first QPSK modulation signal stream s₀ out of the two interference signal streams (s₀, s₁), the ML detector 410 redefines Equation (3) in the form of Equation (5) below taking into account the probability of the null state where the remaining interference signal stream s₁ is not transmitted.

$$LLR ( {b}_{i} ) = log \{ \frac{\frac{( 1 - q )}{16} {\sum }_{{s}^{1} ∈ {C}_{i , 2}^{1}} P ( y \vert s = {s}^{1} ) + \frac{q}{4} {\sum }_{{x}^{1} ∈ {C}_{i , 1}^{1}} P ( y \vert s = {s}^{1} )}{\frac{( 1 - q )}{16} {\sum }_{{s}^{0} ∈ {C}_{i , 2}^{0}} P ( y \vert s = {s}^{0} ) + \frac{q}{4} {\sum }_{{x}^{0} ∈ {C}_{i , 1}^{0}} P ( y \vert s = {s}^{0} )} \} \qquad ( 5 )$$

where q represents the probability of the null state in which the BW REQ message is not received, among the BW REQ messages, the number of which corresponds to the number of BW REQ indicators the BS has received. The q is determined through negotiation between the MS and the BS in a call setup process for each MS. In other words, the BS may determine and control in advance the ratio of MSs capable of sending only a BW REQ indicator among all active MSs, depending on the load condition.

In addition, c_{i,2}¹ and c_{i,2}⁰ represent, respectively, a candidate set for a case where bᵢ in a set of column vectors s=[s₀, s₁] of the BW REQ messages has a value of ‘1’ and a candidate set for a case where bᵢ has a value of ‘0’, when all of BW REQ messages the BS has received are not in a null state. Each set has a size of 8. Similarly, C_{i,1}¹ and C_{i,1}⁰ represent, respectively, a candidate set for a case where bᵢ has a value of ‘1’ and a candidate set for a case where bᵢ has a value of ‘0’ among candidate sets of s₀, assuming that s₁ in the BW REQ messages the BS has received, is in the null state. Each sub set has a size of 2.

To simplify Equation (5), a new variable K_{q} is defined as Equation (6) below:

$${K}_{q} = log ( \frac{1 - q}{4 q} ) \qquad ( 6 )$$

Using K_{q}, Equation (5) may be approximated as Equation (7) below.

$$\begin{matrix}LLR ( {b}_{i} ) = min ( min \{ \frac{{‖ y - {Hs}^{0} ‖}^{2}}{2 {σ}^{2}} \} {\vert}_{{s}^{0} ∈ {C}_{i , 2}^{0}} , \\ {K}_{q} + min \{ \frac{{‖ y - {H}_{1} {s}^{0} ‖}^{2}}{2 {σ}^{2}} \} {\vert}_{{s}^{0} ∈ {C}_{i , 2}^{0}} ) \\ = min ( min \{ \frac{{‖ y - {Hs}^{1} ‖}^{2}}{2 {σ}^{2}} \} {\vert}_{{s}^{1} ∈ {C}_{i , 2}^{1}} , \\ {K}_{q} + min \{ \frac{{‖ y - {H}_{1} {s}^{1} ‖}^{2}}{2 {σ}^{2}} \} {\vert}_{{s}^{1} ∈ {C}_{i , 2}^{1}} )\end{matrix} \qquad ( 7 )$$

The physical meaning of Equation (7) is to calculate by the BS an error distance for a case where two BW REQ messages are received, and a case where one BW REQ message is received. The error distance for the latter case where one BW REQ message is received, means determining the minimum error distance by applying an offset of K_{q} according to the null state. In Equation (7), if a negative number occurs in each ML metric due to K_{q}, it will be treated as ‘0’.

K_{q} determined by the BS's probability of receiving BW REQ messages cannot be estimated. Therefore, in an exemplary embodiment of the present invention, the BS detects an ML of received BW REQ messages using a mapping table representing values corresponding to the determined K_{q}, based on a predefined number of q values.

Table 1 below shows K_{q} associated with probabilities of a predefined number (for example, 6) of null channels.

TABLE 1

| Index | q (Null probability) | K_{q} (ML Metric bias) |
|---|---|---|
| 0 | 1/16 | 1.32 |
| 1 | ⅛ | 0.56 |
| 2 | 3/16 | 0.08 |
| 3 | ¼ | −0.29 |
| 4 | ⅜ | −0.88 |
| 5 | ½ | −1.39 |
| 6 | ¾ | −2.48 |

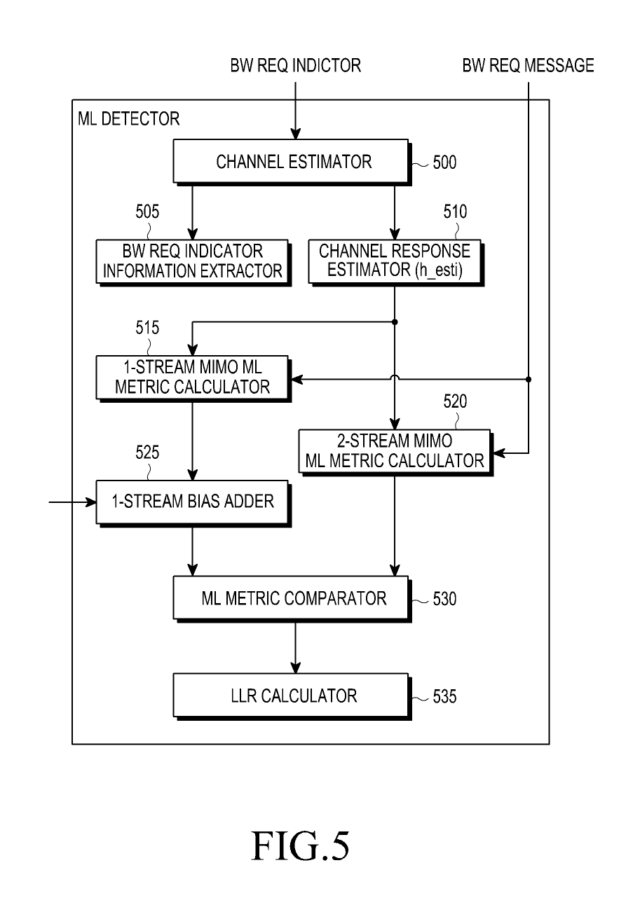

FIG. 5 illustrates a structure of an ML detector according to an exemplary embodiment of the present invention.

Referring to FIG. 5, it is assumed that the receiver 405 has received QPSK modulation signal streams of two BW REQ messages. The ML detector 410 includes a channel estimator 500, a BW REQ indicator information extractor 505, a channel response estimator 510, a 1-stream MIMO ML metric calculator 515, a 2-stream MIMO ML metric calculator 520, a 1-stream bias adder 525, an ML metric comparator 530, and an LLR calculator 535. Upon receiving a BW REQ indicator, the channel estimator 500 estimates a channel over which the BW REQ indicator is sent. The BW REQ indicator information extractor 505 recognizes occurrence of BW REQ from the BW REQ indicator, and the channel response estimator 510 calculates a channel response estimated by the channel estimator 500, and delivers it to the 1-stream MIMO ML metric calculator 515 and the 2-stream MIMO ML metric calculator 520.

The 1-stream MIMO ML metric calculator 515 defines QPSK modulation signal streams of BW REQ messages as interference signal streams. When one of the interference signal streams is in the null state, the 1-stream MIMO ML metric calculator 515 calculates an ML metric (hereinafter referred to as a first metric) for each of a case where a value of bits of an interference signal stream not being in the null state among the interference signal streams is ‘1’, and a case where the bit value is ‘0’, using the channel response estimated by the channel response estimator 510, and delivers the calculated first metrics to the 1-stream bias adder 525. The 1-stream bias adder 525 calculates the probability of the null state in the interference signal streams, calculates K_{q} defined as Equation (6) using the null state probability, adds the K_{q} to each of the first metrics, and delivers them to the ML metric comparator 530. For the K_{q}, the 1-stream bias adder 525 uses the values, which are defined as shown in Table 1 and are determined according to the predefined probability of the null state.

The 2-stream MIMO ML metric calculator 520 defines QPSK modulation signal streams of BW REQ messages as interference signal streams. If the interference signal streams are all not in the null state, the 2-stream MIMO ML metric calculator 520 calculates an ML metric (hereinafter referred to as a second metric) for each of a case where a value of bits for each of the interference signal streams is ‘1’, and a case where the bit value is ‘0’, using the channel response estimated by the channel response estimator 510, and delivers the calculated second metrics to the ML comparator 530.

The ML comparator 530 acquires a first minimum value by comparing the first metric with the second metric for the case where the bit value is ‘1’, acquires a second minimum value by comparing the first metric with the second metric for the case where the bit value is ‘0’, and delivers them to the LLR calculator 535. The LLR calculator 535 acquires an LLR, which is a difference between the first minimum value and the second minimum value.

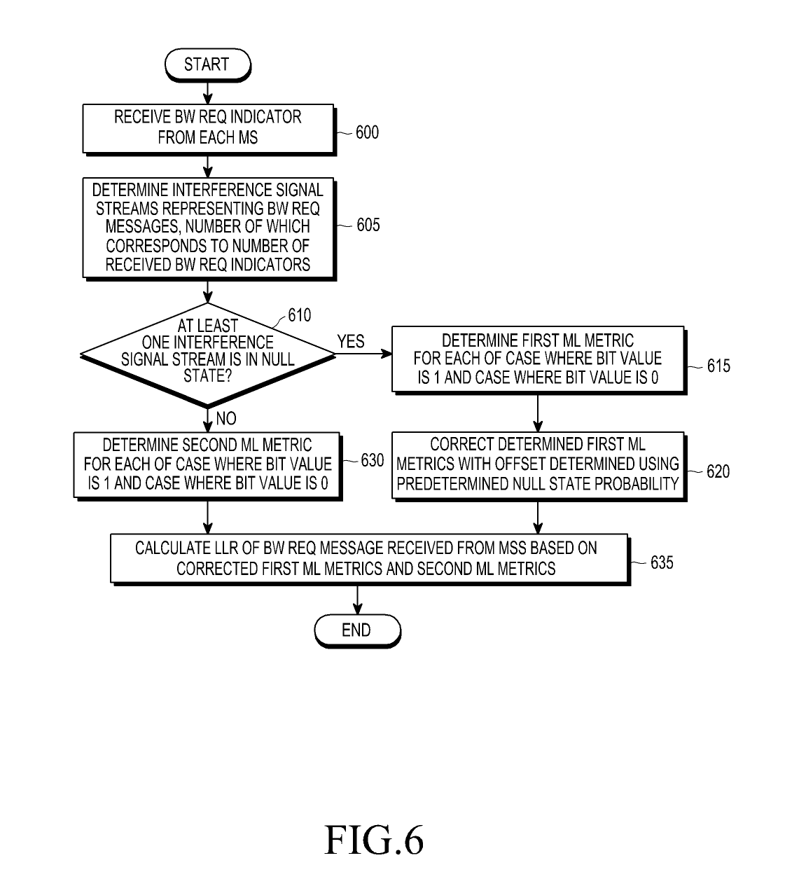

FIG. 6 illustrates an operation of an ML detector according to an exemplary embodiment of the present invention.

Referring to FIG. 6, the ML detector receives BW REQ indicators from MSs in step 600, and determines interference signal streams presenting BW REQ messages, the number of which corresponds to the number of the received BW REQ indicators, in step 605.

In step 610, the ML detector determines if at least one of the determined interference signal streams is in the null state.

If it is determined in step 610 that at least one of the interference signal streams is in the null state, the ML detector determines in step 615 a first ML metric for each of a case where a value of bits constituting each of the remaining interference signal streams except for the interference signal streams being in the null state is ‘1’ and a case where the bit value is ‘0’. In step 620, the ML detector corrects the determined first ML metrics with an offset determined using a predefined null state probability, and proceeds to step 635.

In contrast, if it is determined in step 610 that none of the interference signal streams is in the null state, the ML detector determines in step 630 a second ML metric for each of a case where a value of bits constituting each of the determined interference signal streams is ‘1’, and a case where the bit value is ‘0’. In step 635, the ML detector calculates an LLR of BW REQ messages received from the MSs based on the corrected first ML metrics and the second ML metrics.

As is apparent from the foregoing description, in an exemplary embodiment of the present invention, the BS may use the predefined null state probability, i.e., the probability of failure to receive BW REQ messages even in the situation where it may not accurately determine the number of BW REQ messages received from MSs, making it possible to maintain the detection performance.

The wireless communication system allowing random access may transmit and receive data without the prior resource allocation procedure, and may maintain the detection performance based on the null state probability in the environment where it is not possible to determine in advance the reception of simultaneously transmitted data streams or the number of MSs having transmitted the data streams.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for detecting a received signal by a Base Station (BS) in a communication system, the method comprising:
receiving a BandWidth Request (BW REQ) indicator from each of Mobile Stations (MSs) over a random access channel;
determining first interference signal streams representing BW REQ messages, the number of which corresponds to the number of the received BW REQ indicators;
determining whether the first interference signal streams include at least one second interference signal stream which is in a null state;
if there is no second interference signal stream, determining a first Maximum Likelihood (ML) metric for each of a case where a value of bits constituting each of the first interference signal streams is 1 and a case where the bit value is 0;
if the at least one second interference signal stream is in a null state, determining a second ML metric for each of a case where a value of bits constituting each of third interference signal streams except for the at least one second interference signal stream among the first interference signal streams is 1, and a case where the bit value is 0; and
calculating a minimum error distance of the BW REQ messages received from the MSs based on the first ML metrics and the second ML metrics.

2. The method of claim 1, wherein the calculation of the minimum error distance comprises:
correcting the second ML metric for each of a case where the value of bits constituting the third interference signal stream is 1 and a case where the bit value is 0, with an offset determined based on a predefined null state probability; and
determining a Log Likelihood Ratio (LLR) of a BW REQ message received from each of the MSs based on the corrected first ML metric.

3. The method of claim 1, wherein the predefined null state probability indicates a probability that the number of interference signal streams representing BW REQ messages, the number of which corresponds to the number of the received BW REQ indicators, will be less than the number of the received BW REQ indicators, and is determined by a number that is predefined through negotiation between an MS and the BS in a call setup process for each of the MSs.

4. The method of claim 2, wherein the offset is determined by the following equation:
$${K}_{q} = log ( \frac{1 - q}{4 q} )$$
where K_{q} represents the offset, and q represents the predefined null state probability.

5. The method of claim 1, wherein the BW REQ message is sent in a form of a Quadrature Phase Shift Keying (QPSK) modulation signal stream, and includes a station identifier, a caller identifier, and a requested resource size.

6. The method of claim 1, wherein the reception of a BW REQ indicator comprises receiving from an MS a BW REQ message that is sent along with the BW REQ indicator.

7. The method of claim 6, wherein the MSs having sent a BW REQ message along with a BW REQ indicator are selected as MSs susceptible to latency by the BS, and have already received from the BS a grant message indicating a possibility of simultaneously sending both the BW REQ indicator and the BW REQ message.

8. An apparatus for detecting a received signal in a communication system, the apparatus comprising:
a receiver for receiving a BandWidth Request (BW REQ) indicator from each of Mobile Stations (MSs) over a random access channel; and
a detector for determining first interference signal streams representing BW REQ messages, the number of which corresponds to the number of the received BW REQ indicators, for determining whether the first interference signal streams include at least one second interference signal stream which is in a null state, if there is no second interference signal stream, for determining a first Maximum Likelihood (ML) metric for each of a case where a value of bits constituting each of the first interference signal streams is 1 and a case where the bit value is 0, if the at least one second interference signal stream is in a null state, for determining in advance a second ML metric for each of a case where a value of bits constituting each of third interference signal streams except for the at least one second interference signal stream among the first interference signal streams is 1, and a case where the bit value is 0, and for calculating a minimum error distance of the BW REQ messages received from the MSs based on the first ML metrics and the second ML metrics.

9. The apparatus of claim 8, wherein the detector corrects the second ML metric for each of a case where the value of bits constituting the third interference signal stream is 1 and a case where the bit value is 0, with an offset determined based on a predefined null state probability, and determines a Log Likelihood Ratio (LLR) of a BW REQ message received from each of the MSs based on the corrected first ML metric.

10. The apparatus of claim 8, wherein the predefined null state probability indicates a probability that the number of interference signal streams representing BW REQ messages, the number of which corresponds to the number of the received BW REQ indicators, will be less than the number of the received BW REQ indicators, and is determined by a number that is predefined through negotiation between an MS and the BS in a call setup process for each of the MSs.

11. The apparatus of claim 9, wherein the offset is determined by the following equation:
$${K}_{q} = log ( \frac{1 - q}{4 q} )$$
where K_{q} represents the offset, and q represents the predefined null state probability.

12. The apparatus of claim 8, wherein the BW REQ message is sent in a form of a Quadrature Phase Shift Keying (QPSK) modulation signal stream, and includes a station identifier, a caller identifier, and a requested resource size.

13. The apparatus of claim 8, further comprising a transmitter for sending a grant message indicating a possibility of sending both the BW REQ indicator and the BW REQ message when requesting resources for BW REQ, to MSs that have been selected in advance and are susceptible to latency,
wherein the receiver receives a BW REQ message that has been sent along with the BW REQ indicator, from any MS among the MSs susceptible to latency.

14. The apparatus of claim 13, wherein the MSs having sent a BW REQ message along with a BW REQ indicator are selected as MSs susceptible to latency by the BS, and have already received from the BS a grant message indicating a possibility of simultaneously sending both the BW REQ indicator and the BW REQ message.

15. A method for transmitting a signal in a communication system, the method comprising:
sending both a BandWidth Request (BW REQ) indicator and a BW REQ message to a Base Station (BS) if resources susceptible to latency should be requested; and
receiving from the BS a notification indicating allocation of requested resources that are allocated according to information included in the BW REQ message.

16. The method of claim 13, wherein the BW REQ message is sent in a form of a Quadrature Phase Shift Keying (QPSK) modulation signal stream, and includes a station identifier, a caller identifier, and a requested resource size.

17. The method of claim 15, further comprising receiving from the BS a grant message indicating a possibility of sending both a BW REQ indicator and a BW REQ message,
wherein, if the resources susceptible to latency should be requested, the BS determines the MSs performing initial call setup or starting a specific flow, and the grant message is received at the determined MSs.

18. An apparatus for transmitting a signal in a communication system, the apparatus comprising:
a transmitter for sending both a Bandwidth Request (BW REQ) indicator and a BW REQ message to a Base Station (BS) if resources susceptible to latency should be requested; and
a receiver for receiving from the BS a notification indicating allocation of requested resources that are allocated according to information included in the BW REQ message.

19. The apparatus of claim 18, wherein the BW REQ message is sent in a form of a Quadrature Phase Shift Keying (QPSK) modulation signal stream, and includes a station identifier, a caller identifier, and a requested resource size.

20. The apparatus of claim 18, wherein the receiver receives from the BS a grant message indicating a possibility of receiving both a BW REQ indicator and a BW REQ message,
wherein, if the resources susceptible to latency should be requested, the BS determines the MSs performing initial call setup or starting a specific flow, and the grant message is received at the determined MSs.
